(19) United States
(12) Patent Application Publication
(10) Pub. No.: US 2006/0024124 A1
(43) Pub. Date: Feb. 2, 2006

(54) Ring binder mechanism

(75) Inventor: Hung Yu Cheng, Hong Kong (CN)

Correspondence Address: SENNIGER POWERS, ONE METROPOLITAN SQUARE, 16TH FLOOR, ST LOUIS, MO, 63102, US

(73) Assignee: World Wide Stationery Mfg. Co., Ltd.

(21) Appl. No.: 10/900,242

(22) Filed: Jul. 27, 2004

(51) Int. Cl. B42F 3/00

(52) U.S. Cl. 402/70

(57) ABSTRACT

A ring binder mechanism for retaining loose leaf pages on a base structure comprises a frame made of a first material, at least one ring and a bracket. The ring, which is mounted on the frame, is adapted to hold the loose leaf pages for movement along the ring. The frame is pivotally connected to the bracket. The bracket is made of a second material that is of a different malleablility than the first material and is for use in mounting the frame on the base structure.

### BACKGROUND OF THE INVENTION

This invention relates to binders for holding loose leaf pages, and in particular to a binder having an improved hinge.

A typical ring binder mechanism retains loose-leaf pages, such as hole-punched papers, in a file or notebook. The mechanism generally features multiple rings, each including two half ring members capable of selectively opening to add or remove papers, or selectively closing to retain papers and allow them to move along the rings. The ring members are typically mounted on an elongate housing or frame for movement between the open and closed position. Most commonly, the ring members are mounted on respective hinge plates supported by the frame. Usually the frame is riveted or otherwise attached to the spine of the ring binder cover. It is known to pivotally attach the frame to the cover by way of a hinged connection with a bracket. This arrangement has been used to allow a greater range of motion of the notebook cover than if the frame was directly mounted on the spine. For example, a ring binder with a bracket is commonly able to be folded so that the faces of the front cover and the back cover of the notebook are directly opposed to each other. Ring binders without brackets are typically limited in rotation of the covers to about 180 degrees.

The hinged connection is conventionally a piano hinge, formed by aligned knuckles on the frame and bracket which receive a hinge pin. While this construction is generally satisfactory there are a few drawbacks. Forming knuckles on the frame and the bracket requires that they be made of a relatively malleable material. These materials can be more expensive than the sheet metal normally used to form the ring binder mechanism. Malleable materials tend to be softer than the usual sheet metal materials used to form ring binder mechanisms. In order to make up for this lack of strength, the sheet metal material has to be thicker. Therefore, the ring binder mechanism requires more material and is bulkier in construction.

### SUMMARY OF THE INVENTION

Among the several objects and features of the present invention may be noted the provision of a ring binder mechanism which is less costly; the provision of such a mechanism which is easily manufactured; the provision of such a mechanism which provides for a larger selection of suitable materials from which to manufacture the mechanism; the provision of such a mechanism which uses less material in its manufacture; and the provision of such a ring binder which is serviceable and reliable in operation.

A ring binder mechanism according to the present invention is used to retain loose leaf pages on a base structure. The mechanism generally comprises a frame made of a first material, at least one ring mounted on the frame, and a bracket for use in mounting the frame on the base structure. The ring is adapted to hold the loose leaf pages for movement along the ring. The frame is pivotally connected to the bracket, which is made of a second material that is of a different malleablility than the first material.

In another aspect of the present invention, a mechanism generally comprises a frame including a first frame element and a second frame element. The first and second frame elements include spaced apart ears. At least one ring comprises a first ring member mounted on the first frame element and a second ring member mounted on the second ring element. A hinge pin interconnects the first and second frame elements for pivoting motion relative to each other between a closed position wherein the ring members of the ring form a substantially continuous, closed loop for allowing loose-leaf pages retained by the ring to be moved along the ring from one ring member to the other, and an open position wherein the ring members of the ring form a discontinuous, open loop for adding or removing loose-leaf pages from the ring by inserting the hinge pin through the ears of the first and second frame elements.

In yet another aspect of the present invention, a ring binder mechanism is used for retaining loose leaf pages on a base structure. The ring binder mechanism comprises a frame and at least one ring is mounted on the frame. The ring is adapted to hold the loose leaf pages for movement along the ring. A bracket, which has spaced apart ears, is used to mount the frame on the base structure. A hinge pin pivotally interconnects the frame to the bracket by inserting the hinge pin through a portion of the frame and the ears of the bracket.

In still another aspect of the present invention, a method of manufacturing a ring mechanism for retaining loose leaf pages comprises forming a generally planar frame element blank having ears with openings. The ears project from the blank and lie generally in the plane of the blank. The ears are bent so that they lie substantially in a plane forming an angle with the plane of the blank. The method also includes mounting ring members on the blank. The ring members are adapted to mate with other ring members to form a closed ring for retaining the loose leaf pages. In addition, the method includes inserting a hinge pin through the bent ears whereby a frame element made from the frame element blank is pivotable on the hinge pin.

Other objects and features of the present invention will be in part apparent and in part pointed out hereinafter.

### BRIEF DESCRIPTION OF THE DRAWINGS

FIG. 1 is a fragmentary perspective of a ring binder having a ring binder mechanism of the present invention;

FIG. 2 is a fragmentary end elevation of the ring binder and ring binder mechanism;

FIG. 3 is a fragmentary end elevation of the ring binder mechanism similar to FIG. 2 with a back cover and front cover in coplanar relation with a frame of the mechanism pivoted away from the bracket;

FIG. 4 is the fragmentary end elevation of FIG. 3 with the frame pivoted toward the bracket;

FIG. 5 is a fragmentary end elevation of the ring binder with the back cover and front cover in overlying relation and the frame pivoted away from the bracket;

FIG. 6 is a fragmentary end elevation of another ring binder having front and back covers retained on rings of a ring mechanism in a closed position;

FIG. 7 is the end elevation of FIG. 6 with the front and back covers of the ring binder in an open position;

FIG. 8 is a fragmentary end elevation similar to FIG. 6 but with the front and back covers of the notebook in face-to-face relation;

FIG. 9 is a perspective of the ring binder mechanism of FIG. 1 in a closed position;

FIG. 10 is a side elevation of the mechanism of FIG. 9;

FIG. 11 is a top plan view of the mechanism of FIG. 9;

FIG. 12 is a longitudinal section of the mechanism taken along the line 12-12 of FIG. 11;

FIG. 13 is a traverse section of the mechanism taken along the line 13-13 of FIG. 11;

FIG. 14 is a perspective of first and second frame elements of the mechanism;

FIG. 15 is an exploded perspective view of the mechanism;

FIG. 16 is a perspective of the mechanism in a open position;

FIG. 17 is a perspective of another version of the ring binder mechanism in a closed position having an alternative ring configuration;

FIG. 18 is a perspective of the mechanism of FIG. 17 in a open position;

FIG. 19 is a perspective of a second embodiment of the ring binder mechanism in a closed position;

FIG. 20 is a perspective of the mechanism of FIG. 19 in an open position;

FIG. 21 is an exploded perspective of the mechanism of FIG. 19;

FIG. 22 is a perspective of the mechanism of FIG. 17 without a bracket;

FIG. 23 is a diagrammatic perspective view illustrating the manufacturing process of a first frame element; and

FIG. 24 is a diagrammatic perspective view illustrating the manufacturing process of a second frame element.

Corresponding reference characters indicate corresponding parts throughout the views of the drawings.

### DETAILED DESCRIPTION OF THE PREFERRED EMBODIMENT

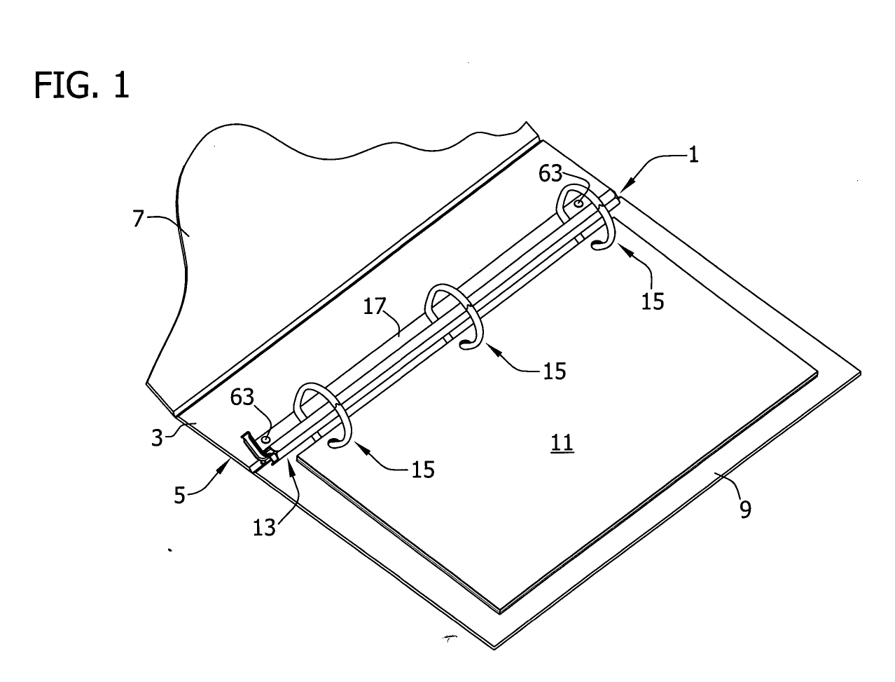

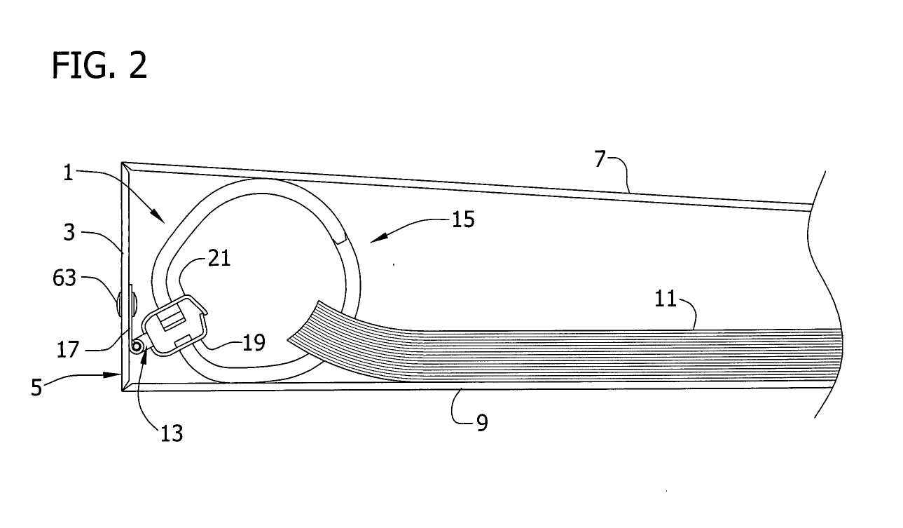

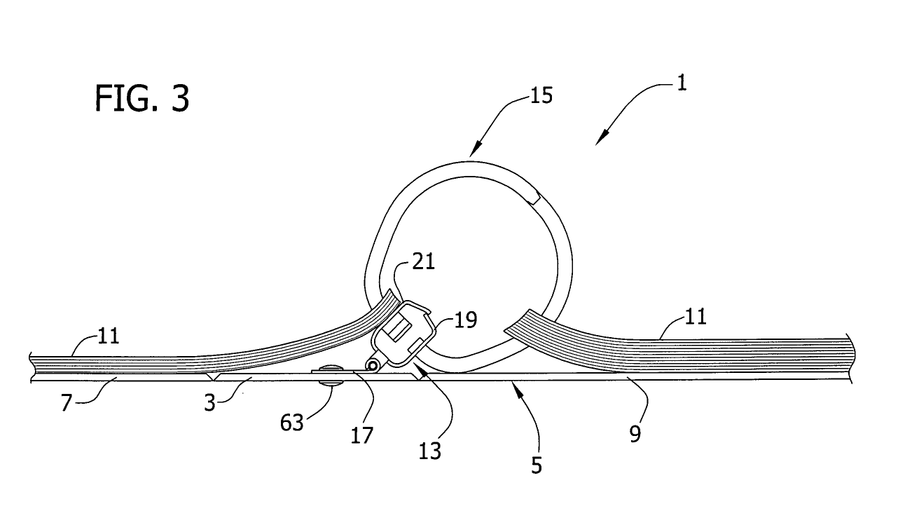

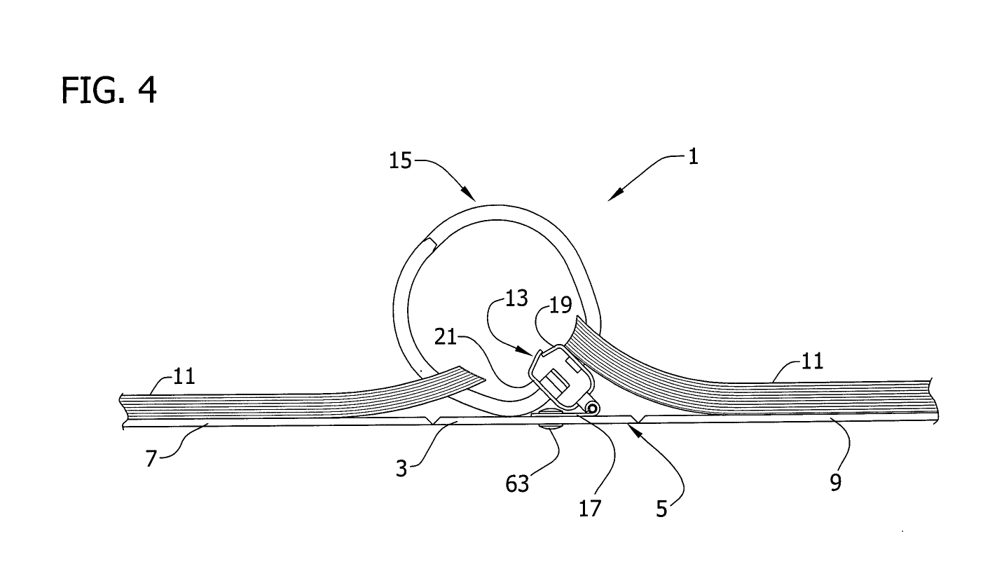

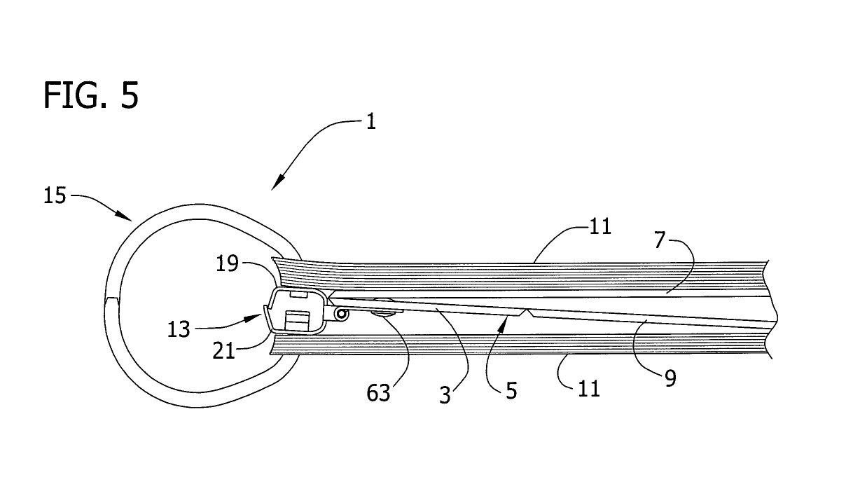

Referring now to the drawings and in particular to FIG. 1, a ring binder mechanism for retaining loose leaf pages according to the present invention is indicated generally at 1. The mechanism is shown mounted on a spine 3 of a ring binder (broadly, “a base structure”), indicated generally at 5, having a front cover 7 (partially shown) and a back cover 9 hingedly attached to the spine. While the ring binder mechanism 1 is shown mounted on a spine 3 of a ring binder 5, the mechanism can be mounted on other surfaces without departing from the scope of this invention. The front and back covers 7, 9 of the ring binder 5 are adapted to move to selectively cover or expose the pages retained by the ring binder. In FIG. 2, the front and back covers 7, 9 are shown cooperatively covering the retained loose leaf pages 11 thereby protecting them from dirt and damage. The front and back covers 7, 9 can be moved to several positions which expose, and thereby provide access to, the retained pages 11 (FIGS. 3-5). As shown in FIGS. 3 and 4, the front and back covers 7, 9 can be placed in a conventional side-by-side relation or, as shown in FIG. 5, in face-to-face relation.

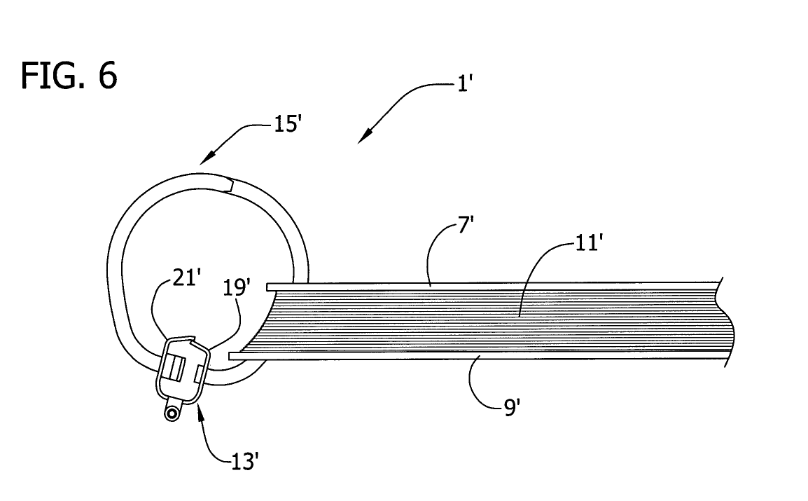

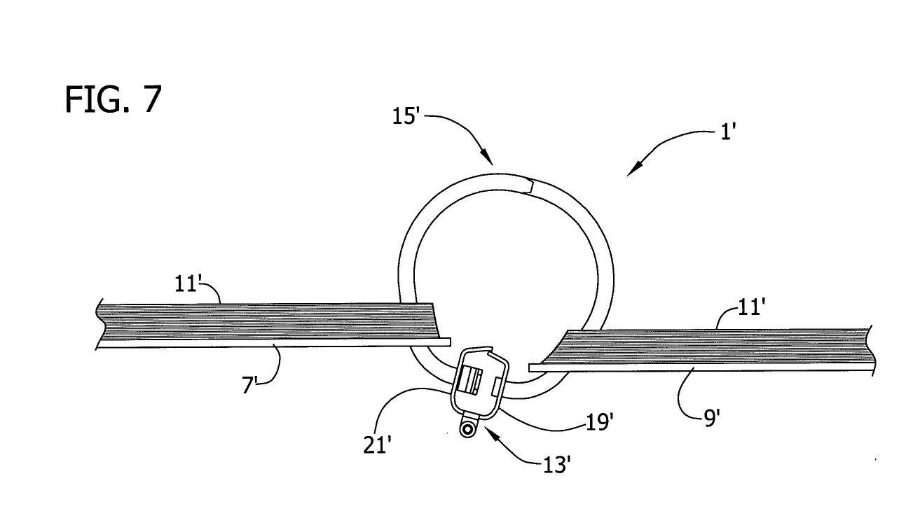

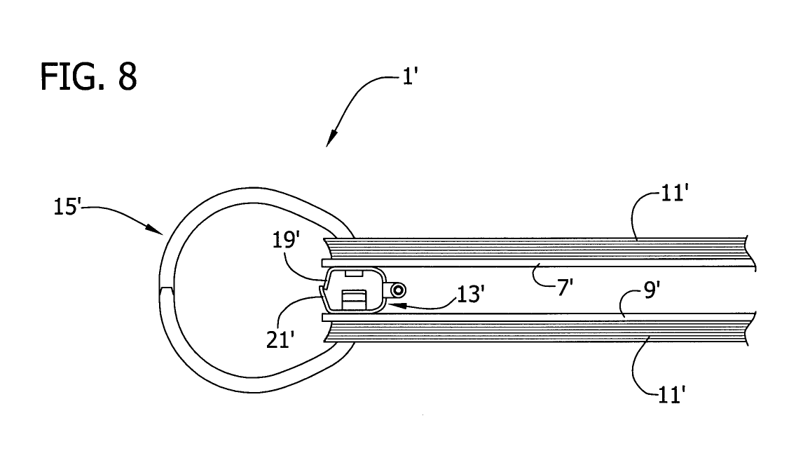

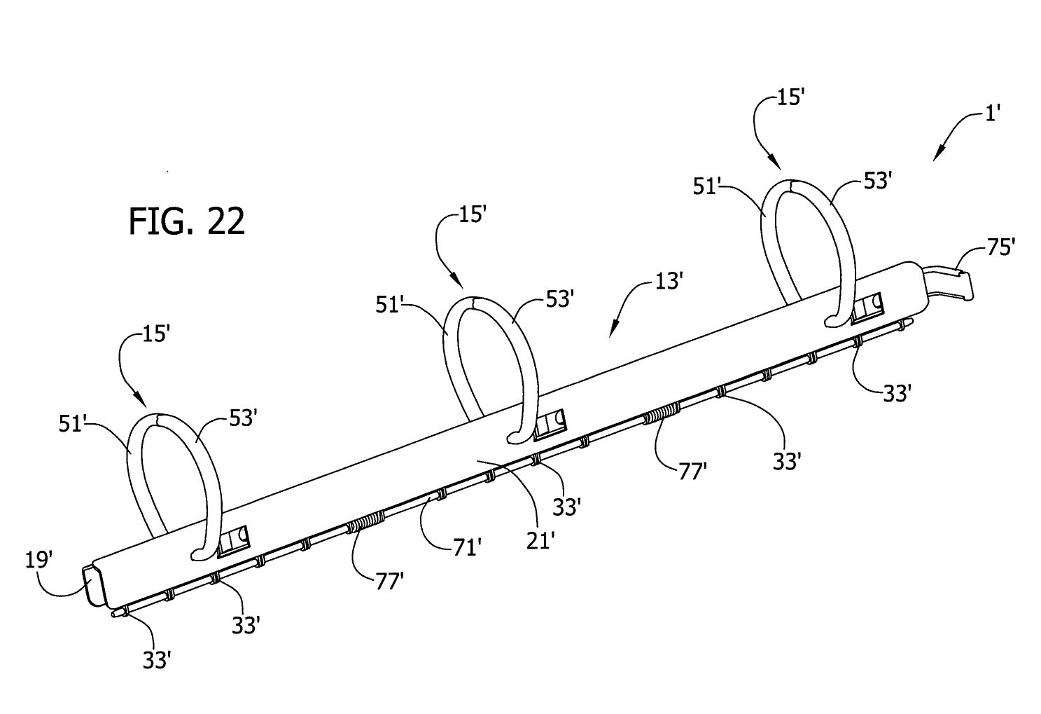

A modified version of the ring binder 5′ is shown in FIGS. 6-8. In this variation, the ring binder mechanism 1′ is not mounted on a spine, front cover 7′ or back cover 9′ of the ring binder 5′. Instead, the front and back covers 7′, 9′ are retained on the ring binder mechanism 1′ in the same manner as the loose leaf pages 11′. The ring binder mechanism 1′ without the front and back covers 7′, 9′ is shown in FIG. 22. Corresponding parts of the ring binder 1′ of FIGS. 6-8 are indicated by the same reference numerals as the ring binder of FIG. 1, with a trailing “prime”.

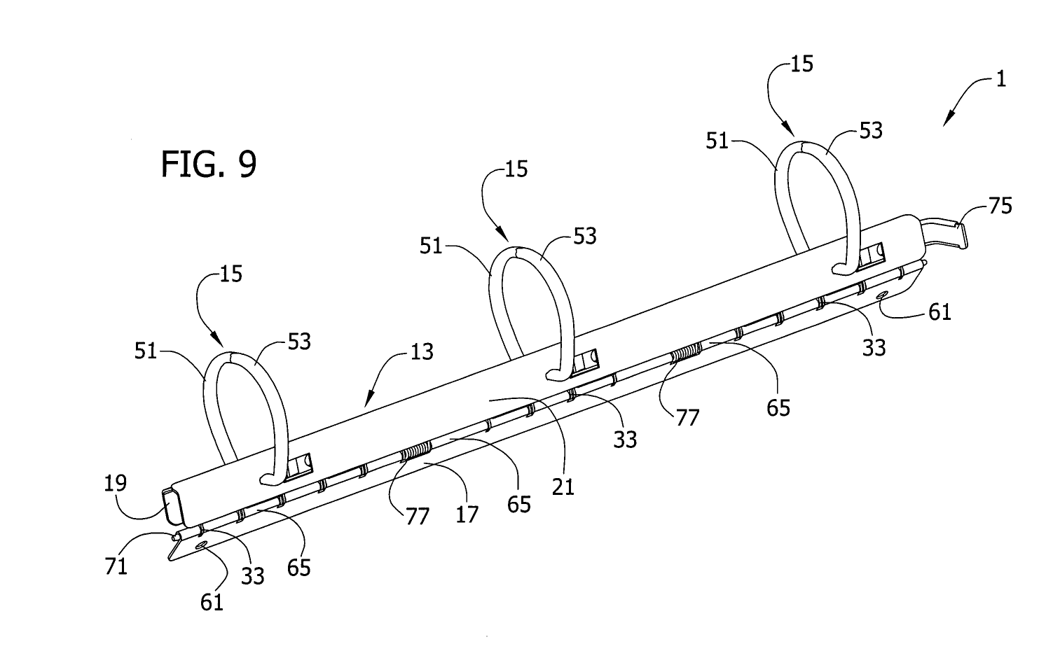

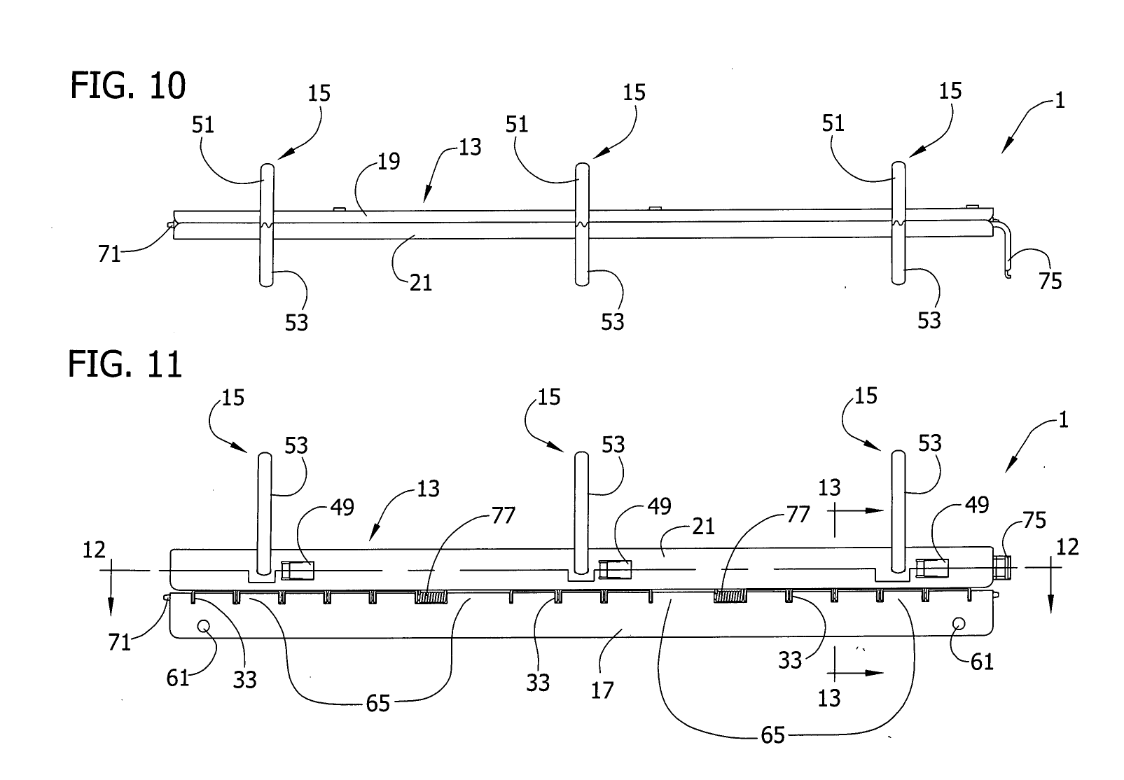

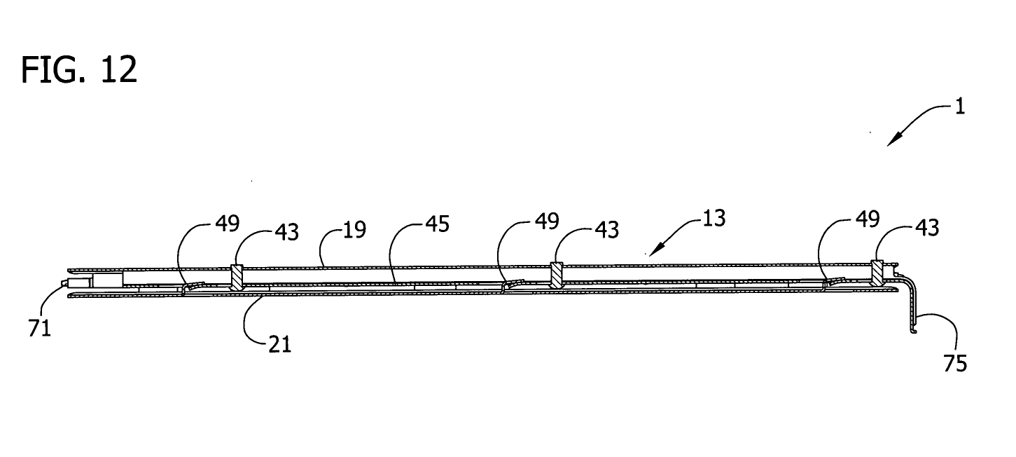

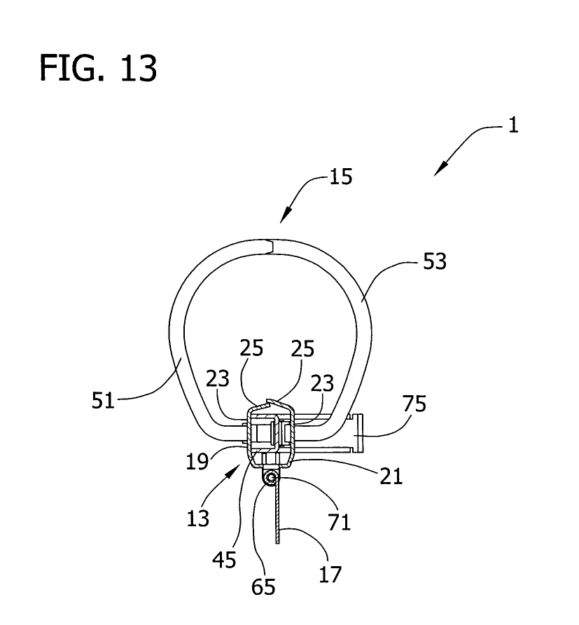

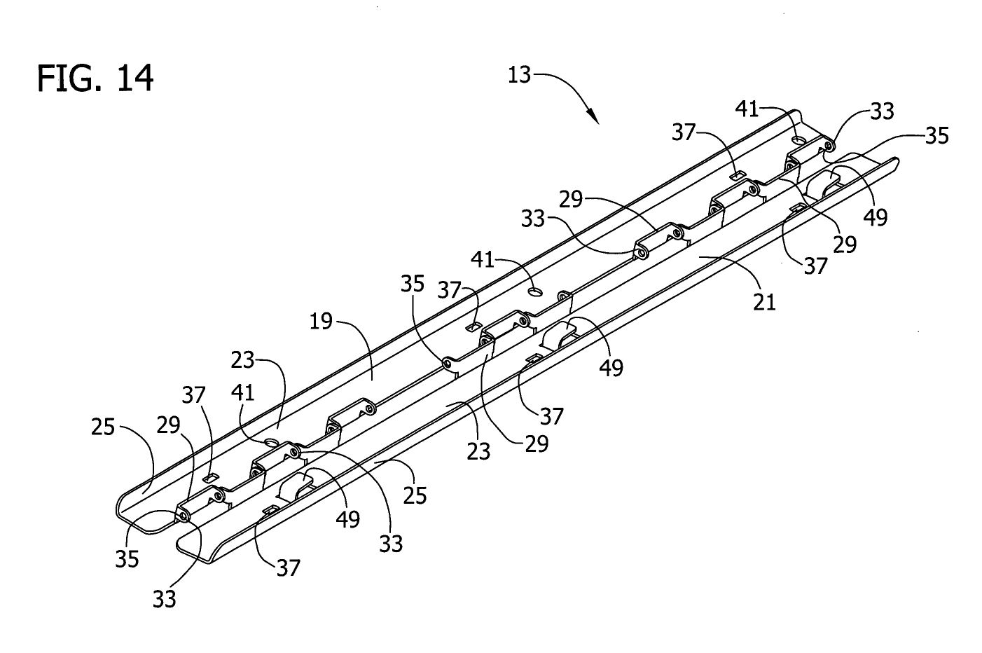

Referring to FIG. 9, the mechanism 1 of the first embodiment comprises a frame (generally indicated at 13), three rings (each generally indicated at 15), and a bracket 17. As better shown in FIGS. 10-13, the frame 13, which is elongate and has a roughly rectangular cross-section, comprises a first frame element 19 and a second frame element 21. Each frame element 19, 21 is formed from sheet metal and has a web 23 and an outer flange 25 (FIG. 14). The outer flanges 25 of the elements 19, 21 extend angularly outward from an outer edge of the web 23 such that an angle between the outer flange and the web is greater than 90 degrees. The angle between the outer flange 25 and the web 23 of the first frame element 19 is less than the angle between the outer flange 25 and the web 23 of the second frame element 21. As a result, in a closed position, the outer flange 25 of the second frame element 21 slightly overlaps the outer flange 25 of the first frame element 19 (FIG. 13). Accordingly, no gaps are present between the first and second frame elements 19, 21 when the mechanism 13 is in a closed position. Each of the webs 23 of the frame elements 19, 21 comprises multiple, spaced apart tabs 29 formed on its inner edge (FIG. 14). The tabs 29 each extend angularly outward from the same side of the web 23 as the outer flange 25, giving each of the first and second frame elements 19, 21 a generally channel shaped cross-section.

While a frame 13 comprising two frame elements 19, 21 is shown, it is understood that frame may have a different configuration without departing from the scope of the invention. For example, the frame may comprise more or fewer elements and the elements may have different sizes and shapes, and be made from materials other than sheet metal.

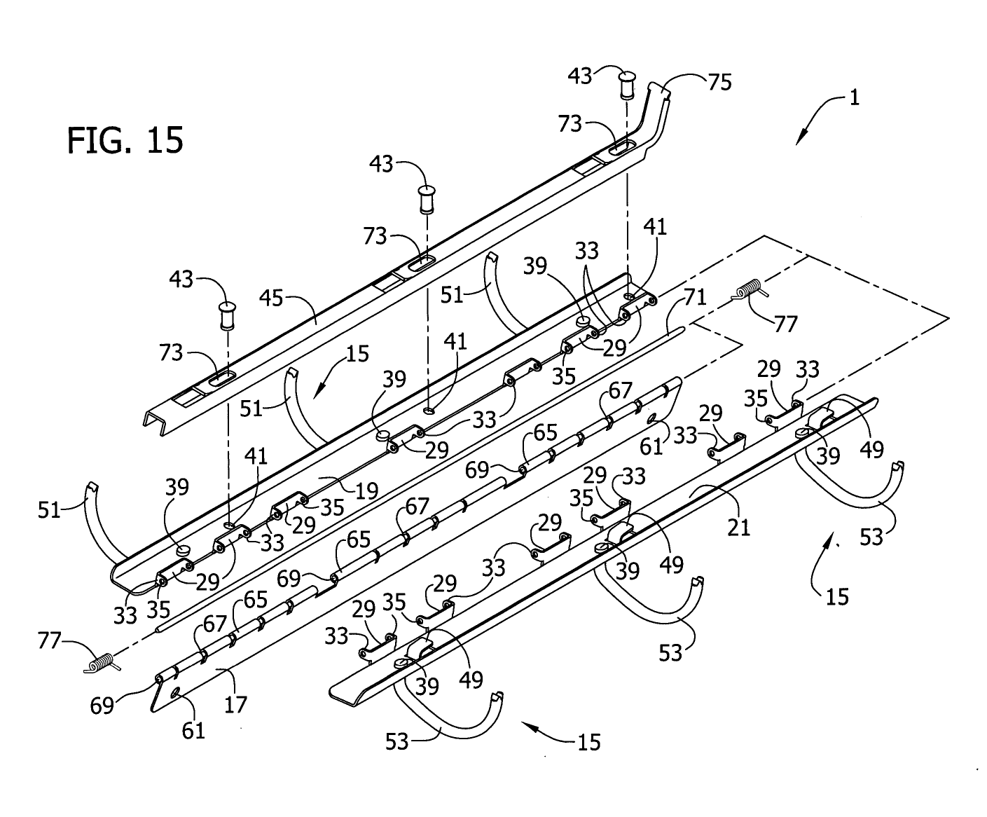

As shown in FIGS. 14 and 15, the first and second frame elements 19, 21 each further comprise ears 33 with openings 35. The ears 33, which are thin and flat, are attached on opposite sides of the tabs 29, near the end of the tab remote from the web 23. Each tab 29 has a pair of ears 33 associated with it. The ears 33 project laterally outwardly from the tabs 29 and the first and second frame elements 19, 21. The tabs 29 lie in a plane generally perpendicular to a plane in which the web 23 lies. The ears 33, tabs 29, and the associated frame element 19, 21 comprise a one-piece structure. However, the ears 33 or tabs 29 may be formed separately from the frame element 19, 21 and then connected to the element. Furthermore, the ears 33 and tabs 29 may have different configurations without departing from the scope of this invention.

Each of the frame elements 19, 21 has three generally rectangular openings 37 (FIG. 14) receiving ends 39 of the rings 15 (FIG. 15) to mount the ring on the frame element. The ring ends 39 are inserted into the openings 37 and the ends are beaten or pressed down to make a head that is larger than the opening thereby securing the ring to the frame element. The rings 15 may be secured to the frame elements 19, 21 using other techniques (e.g., welding) without departing from the scope of this invention.

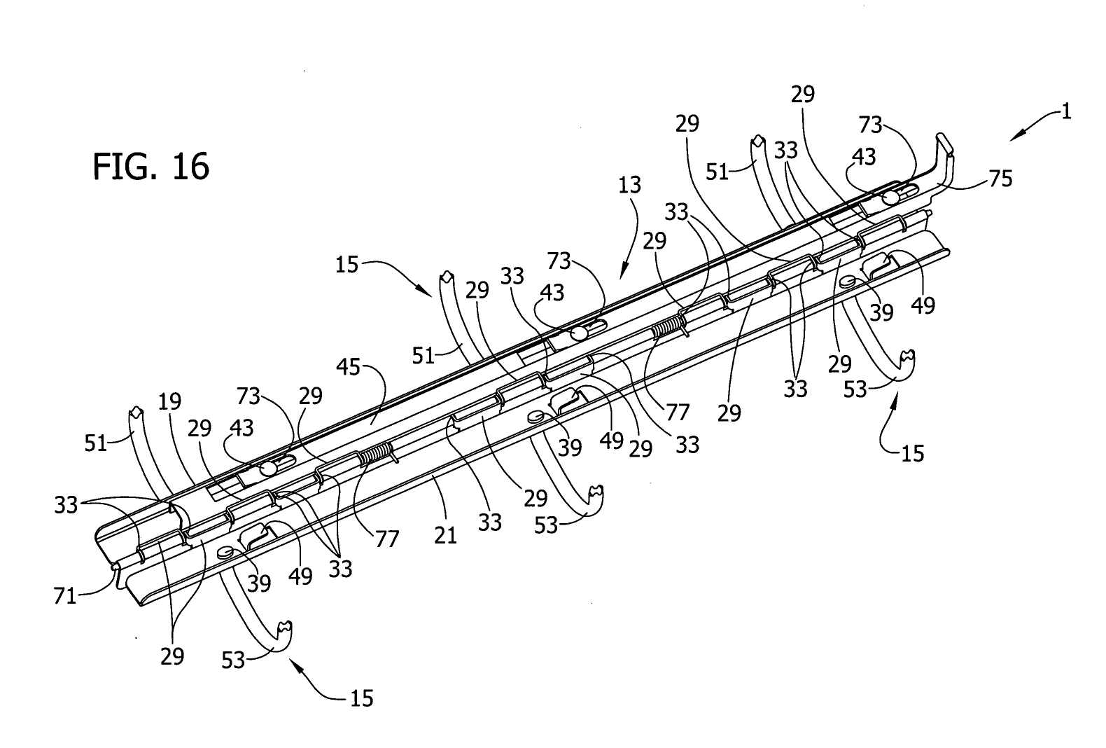

The first element 19 also comprises three circular openings 41 (FIG. 14) receiving posts 43 attaching a slidable lock bar 45 forming part of a locking device (FIGS. 15 and 16). The second frame element 21 is formed with three catches 49 for releasable engagement with the lock bar 45. The locking device and its components are described in more detail below.

Referring now to FIG. 15, each of the three rings 15 mounted on the frame 13 comprising a first ring member 51 mounted on the first frame element 19 and a second ring member 53 mounted on the second frame element 21. The ring members 51, 53 are movable relative one another between a closed position (shown in FIG. 9) and an open position (shown in FIG. 16). In the closed position, the ring members 51, 53 form a substantially continuous, closed, ring or loop for retaining loose-leaf pages 11 and for allowing the pages to move along the rings 15 from one ring member to the other. In the open position, each ring 15 forms a discontinuous, open loop suitable for adding or removing pages.

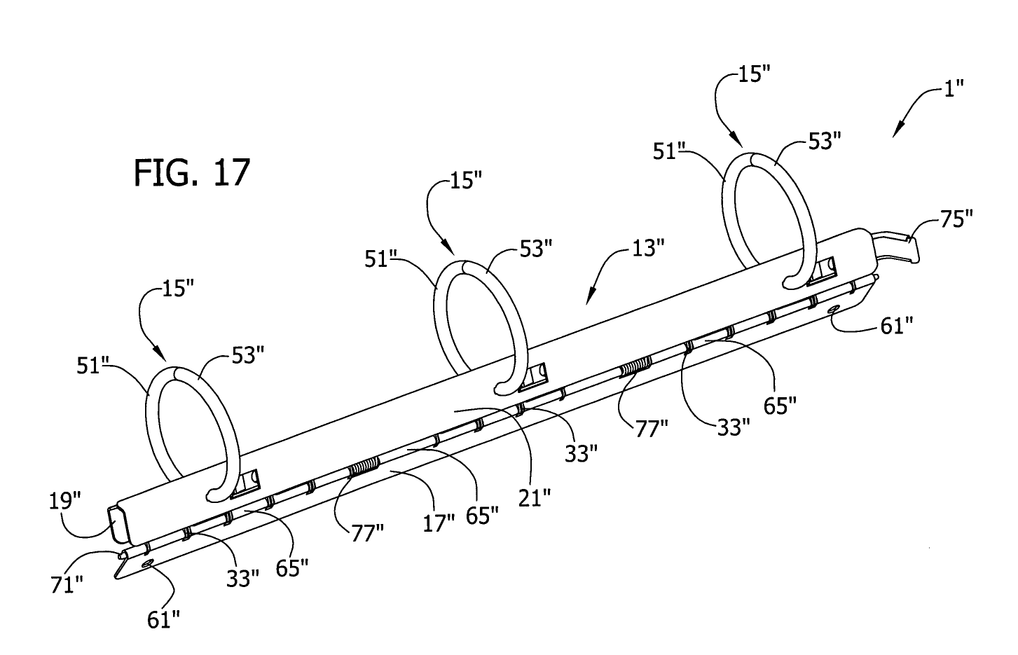

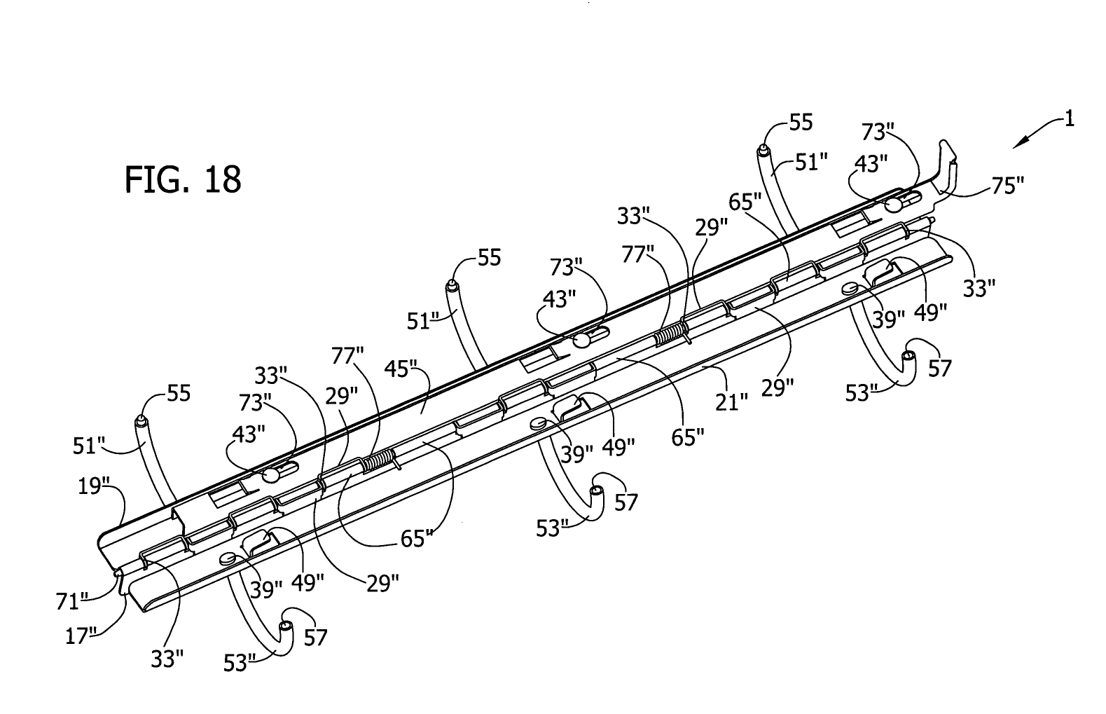

In another version of the ring binder mechanism 1″, a first ring member 51″ is formed with a protrusion 55 at a distal end, and a second ring member 53″ is formed with a recess 57 at a distal end adapted to receive the protrusion of the first ring member (FIGS. 17 and 18). As a result, the first and second ring members 51″, 53″ are held from transverse displacement relative to each other in the closed position. Moreover, no gaps are formed between the first and second ring members 51″, 53″. It is advantageous to eliminate the potential of gaps between the ring members 51″, 53″ since gaps may allow retained loose leaf pages (not shown) to slide off the ring 15″. The ring binder mechanism 1″ of FIGS. 17 and 18 is of the same construction as the mechanism 1 of FIGS. 1-5 and 9-16 except for the protrusions 55 and recesses 57 of the rings 15″. Therefore, corresponding parts are indicated by the same reference numerals with the addition of a double prime.

Although in the illustrated embodiment both ring members 51, 53 can move, mechanisms having one movable ring member and one fixed ring member do not depart from the scope of this invention. It is envisioned that the ring members are formed of a conventional, cylindrical rod of suitable material, such as steel. But it is understood that ring members having a different cross section or ring members made of different material do not depart from the scope of the present invention. In addition, ring binder mechanisms with more or fewer than three rings or with rings that form other shapes, such as “D” or slanted “D” shapes, when the ring members are closed, do not depart from the scope of this invention.

With reference to FIG. 9, the frame 13 is pivotally connected to the bracket 17 used to mount the frame on the ring binder 5. In one embodiment, the bracket 17 is a generally planer sheet metal member having a length and width approximately equal to a length and width of the frame. The bracket 17 has two, spaced apart apertures 61 for receiving fasteners 63 (FIG. 1) for mounting the bracket on the ring binder 5. Referring now to FIG. 15, the bracket 17 further includes, along one of its side edges, a plurality of knuckles 65. The knuckles 65 are preferably formed by rolling an edge or a portion of an edge of the sheet metal member into a tube. Spaces 67 between adjacent knuckles 65 located along the length of the bracket 17 receive the ears 33 of the frame elements 19, 21. Each knuckle 65 defines a passage 69 having opposite ends. The spaces 67 separating the knuckles 65 can be formed before or after the tube is formed. In this embodiment, the bracket 17 is made of a sheet metal material that is of a greater malleability than the sheet metal material used to make the frame 13 or portions thereof, such as the ears 33. The material used for the frame 13 can be less malleable than the material used for the bracket 17 since no portion of the frame requires rolling. The frame 13 and/or the bracket 17 may be made from materials other than sheet metal without departing from the scope of this invention. It is also understood that the bracket 17 can be formed in a variety of shapes and sizes without departing from the scope of this invention. Moreover, the number of apertures 61 or knuckles 65 may also vary.

It is envisioned that knuckles 65 could be formed on the first and second frame elements 19, 21, and tabs 29 and ears 33 could be formed on the bracket 17 (not shown). However, a benefit of forming the ears 33 on the first and second frame elements 19, 21 is that they can be made of a harder (but less malleable) sheet metal. The harder sheet metal can better mount the ring members 51, 53 using a lesser thickness of sheet metal. The stamping and simple bends needed to form tabs 29 and ears 33 are well within the performance capability of the harder sheet metal without requiring special bending techniques. In one version of the ring binder mechanism 1, the first and second frame elements 19, 21 are made out of Japanese JIS SPCC-1B steel sheet metal having a hardness of HRB 85 or greater. The bracket 17 is formed of Japanese JIS SPCC-4B steel sheet metal having a hardness of HRB 65-80.

As may be seen in FIG. 14, the first and second frame elements 19, 21 are constructed so that certain pairs of ears 33 on one element are received between ears of adjacent tabs 29 on the other element. In any event, at least one ear 33 of each tab 29 of the first element 19 engages the ears of a corresponding tab on the second element 21. The engagement of the ears 33 positions the frame elements 19, 21 relative to each other in a lengthwise direction. The ears 33 are received in the spaces 67 between knuckles 65 on the bracket 17 (FIG. 16). Interengaged ears 33 of the first and second frame elements 19, 21 are received in the same space 67. The openings 35 in the ears 33 and the passages 69 of the knuckles 65 are aligned and received a hinge pin 71 therethrough pivotally interconnecting the first and second frame elements 19, 21 to each other and to the bracket 17. Thus, the frame 13 can pivot on the hinge pin 71 relative to the bracket 17 (e.g., as between the position shown in FIG. 3 and the position shown in FIG. 4). In addition, the first and second frame elements 19, 21 can simultaneously pivot on the hinge pin 71 relative to each other between the closed position shown in FIG. 9 and the open position shown in FIG. 16.

With particular reference to FIG. 15, the locking device is used to lock the first and second frame elements 19, 21 in the closed position. The locking device comprises the lock bar 45 slidably mounted on the first frame element 19 for movement between a locked position in which the lock bar is positioned to engage the second frame element 21 and hold it in the closed position of the frame elements, and an unlocked position in which the lock bar disengages the second frame element to permit the first and second frame elements to pivot on the hinge pin 71 to the open position. The lock bar 45 is slidably mounted on the first frame element 19 by the three posts 43. The posts extend through three elongate openings 73 in the lock bar 45 and are affixed to the first frame element 19. The travel of the locking bar 45 is limited by the extent of the openings 73. The second frame element 21 has three catches 49 for engagement with the lock bar 45 and holding the frame elements in the locked position. The catches 49 are formed by striking up material from the second frame element 21. The lock bar 45 is manually positionable using a finger grip 75 integrally connected to an end of the lock bar. Torsion springs 77 mounted on the hinge pin 71 bias the first and second frame elements 19, 21 to the open position when the locking bar 45 is moved to release the catches 49 the first and second frame elements are biased to open (FIG. 16). To close the frame elements 19, 21, they are manually pushed together against the bias of the springs 77 and the lock bar 45 is slid to capture the catches 49. Other locking devices capable for retaining the ring members in a closed position may be used without departing from the scope of this invention.

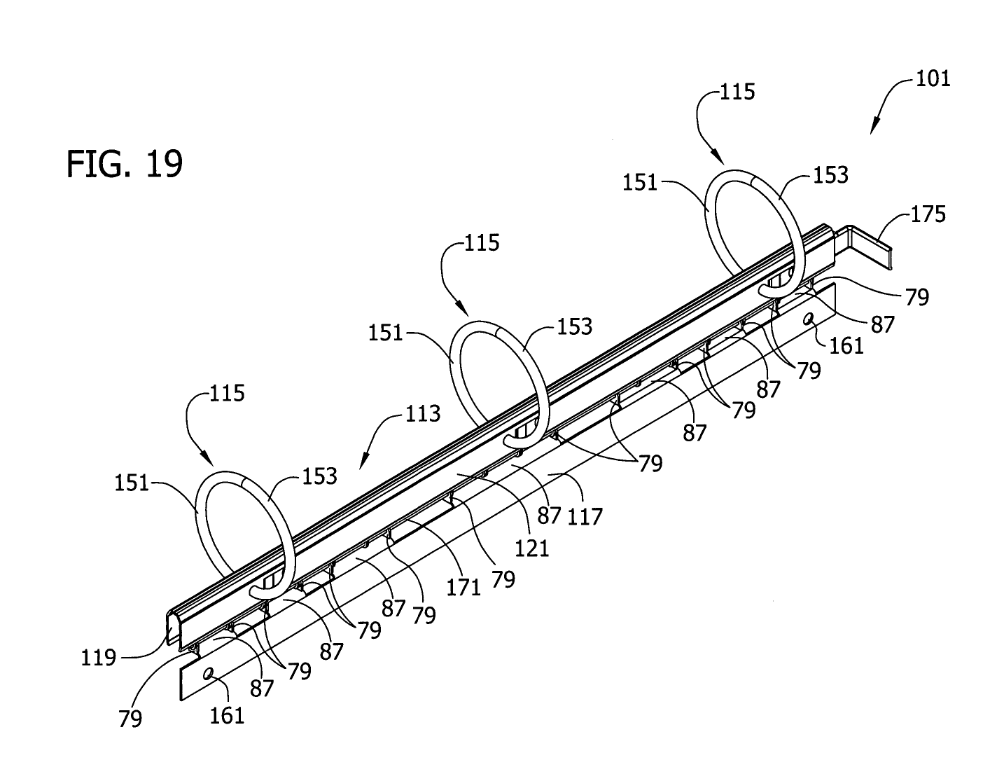

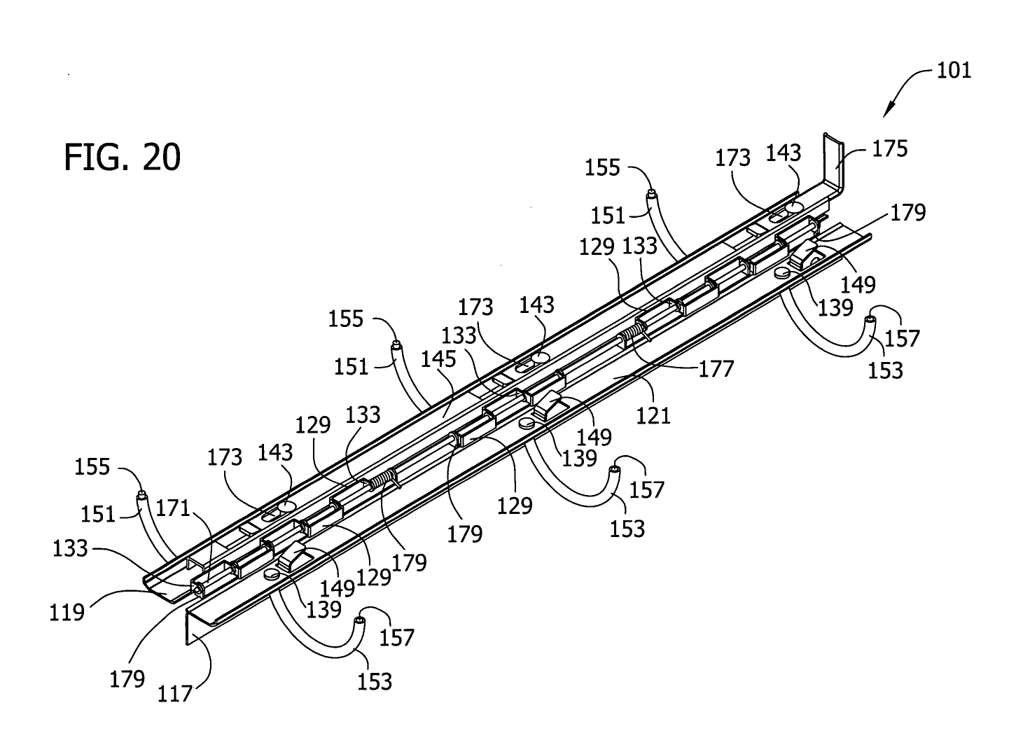

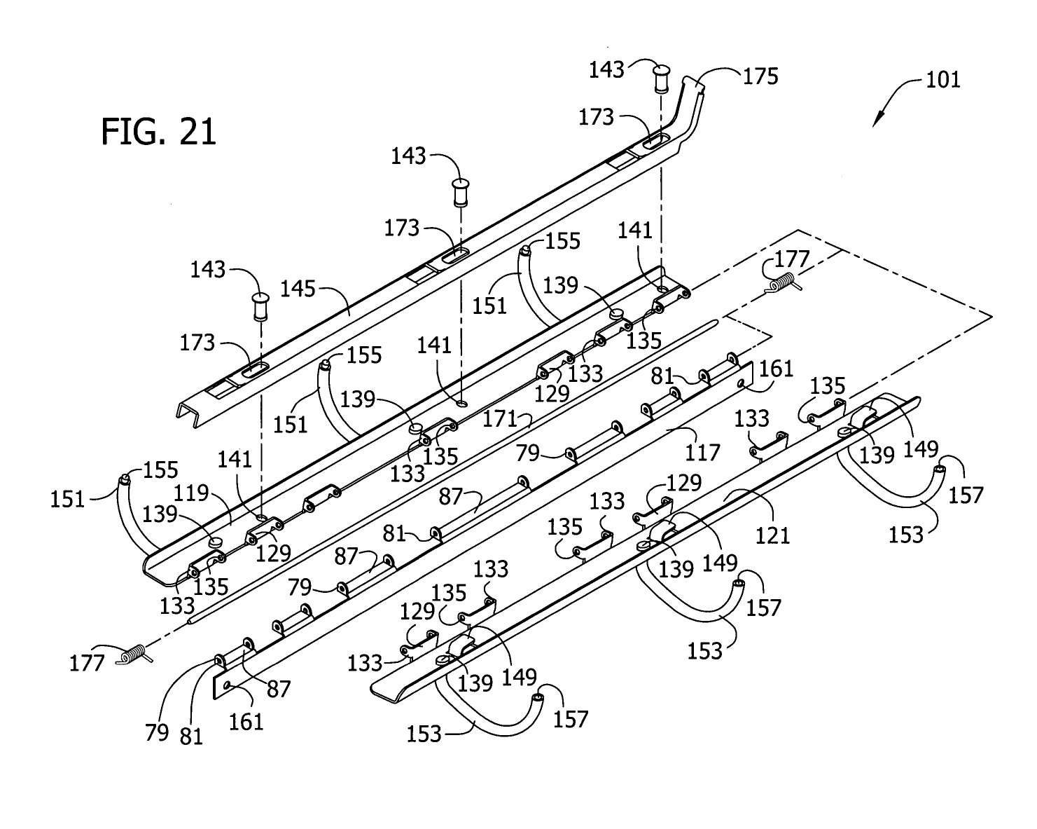

In a second embodiment of the ring binder mechanism 101 shown in FIGS. 19-21, a bracket 117 can be formed with tabs 87 and ears 79 with openings 81 having substantially the same configuration as described above with respect to the tabs 29 and ears 33 formed on the frame elements 19, 21 of FIGS. 1-5 and 9-16. In this embodiment, the bracket 117 may be made from the same (e.g., hard and thin) material used to make the frame elements 119, 121 or from a different material. The ring binder mechanism 101 is closely similar to the mechanism 1″ shown in FIGS. 17 and 18. Accordingly, corresponding parts are indicated by the same reference numbers, plus “100” and without the double prime.

Since ears 133, 79 can be made without rolling any portion of the frame elements 119, 121 or the bracket 117, a wider selection of suitable materials are available for use in making the frame elements and the bracket. Importantly, the costs for harder sheet metal, which is suitable for forming ears 133, 79 but unsuitable for rolling knuckles 65 (FIG. 15), is typically less. Moreover, the ears 133, 79 are formed using less material than a comparative knuckle 65. The hinge pin 171 is received through openings 135, 81 in the ears 133, 79 to pivotally interconnect the frame elements 119, 121 and bracket 117.

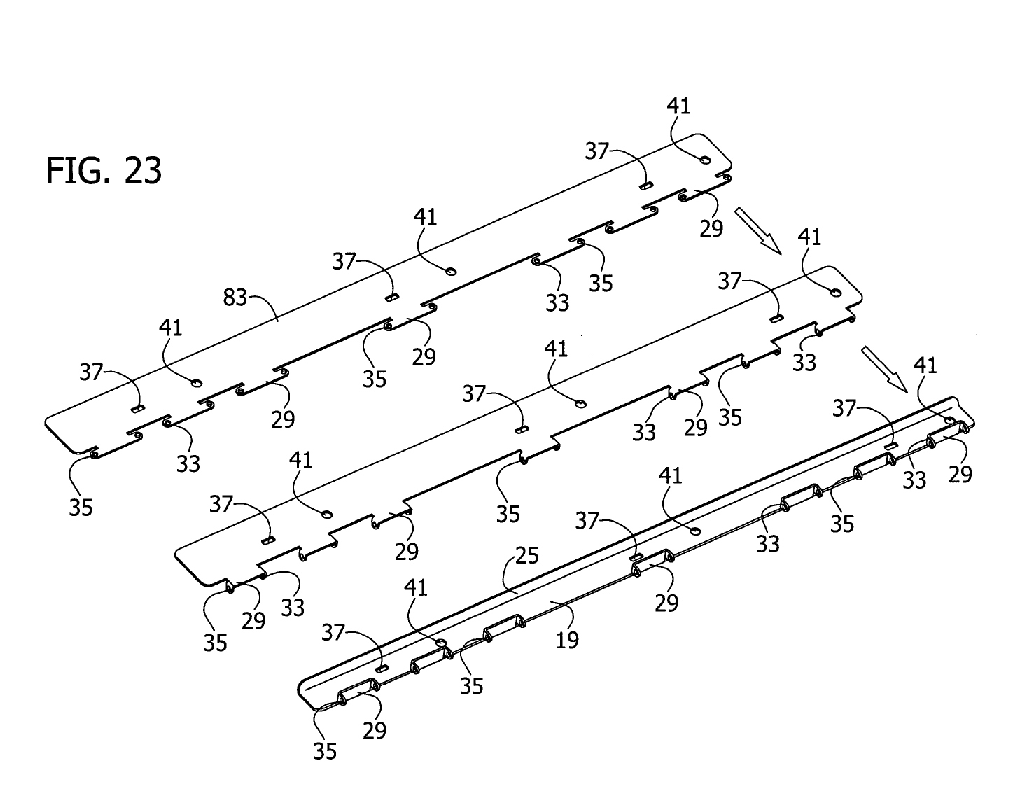

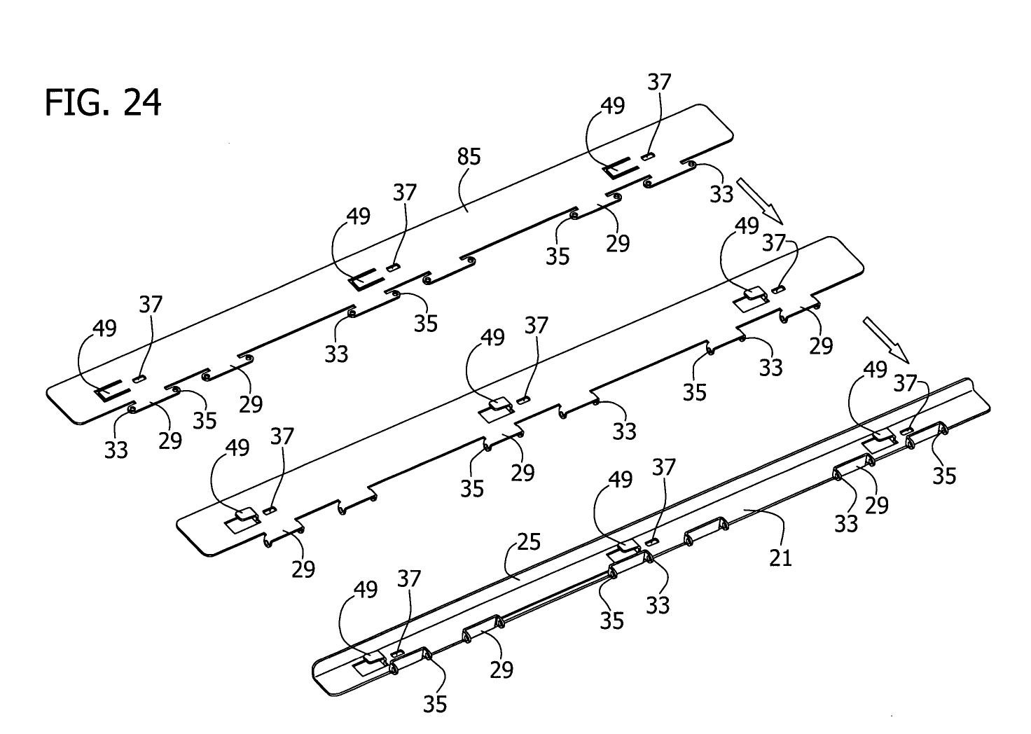

A method of forming first and second frame elements 19, 21 of a ring binder mechanism 1 of the present invention is diagrammatically illustrated in FIGS. 23 and 24. The first frame element 19 is shown in three successive stages of formation in FIG. 23. First, a blank 83 is formed by stamping from sheet metal. The blank 83 has tabs 29 projecting out from the blank, each tab having a pair of ears 33 on opposite sides of the tab. The ears 33 lie in the plane of the tabs 29 and the blank 83. Openings 37 for receiving ring members 51, and openings 41 for posts 43 to mount a lock bar 45 are also formed. The ears 33 are then bent downward (in the orientation shown in FIG. 23) so that they form an angle with the blank 83 and tabs 29, as shown in the middle representation. Subsequently, the tabs 29 are bent up so that the tabs make an angle with the plane of the blank 83 and the ears 33 make an angle with both the plane of the blank and the plane of the tab. The outer edge margin of the blank 83 (opposite the tabs 29) is bent up, creating flange 25 and giving the first frame element 19 a substantially channel shape. Although not shown in FIG. 23, ring members 51, 53 and posts 43 are secured to the first frame element 19. The locking bar 45 (also not shown) is slidably mounted on the posts 43.

The second frame element 21 is formed in a similar fashion, as shown in FIG. 24. A blank 85 is formed by stamping from sheet metal. Tabs 29 and ears 33 are formed, but in locations which are offset from the locations of the tabs and ears formed on the first frame element 19 to permit the ears to be intermeshed when the frame elements are assembled. Openings 37 for the ring members 51, 53 are also formed, along with catches 49 that remain coplanar with the blank 85 in this initial step. The ears 33 are then bent downward out of plane of the tabs 29 and blank 83. The catches 49 are also bent upward to their final configuration. The outer edge margin of the second frame element 21 is bent up to create flange 25 and give the second frame element a channel shape. Although not shown in FIG. 24, ring members 51, 53 are attached to the second frame element 21. The bracket 17 can be formed in a similar stamping operation. However, for the embodiment of FIGS. 1-16, projections stamped into the bracket blank (not shown) are rolled to produce the knuckles 65. In the embodiment of FIGS. 19-21, tabs 87 and ears 79 on the bracket 17 are formed in a way similar to what is described herein for the ears 33 of the first and second frame elements 19, 21.

The first and second frame elements 19, 21 are brought into registration so that the ears 33 intermesh and many of the ears are immediately adjacent each other. The bracket 17 is also brought into registration so that passages 69 in the knuckles 65 (or openings 81 in the ears 79 on the bracket 117) are aligned with the openings 35 of the ears 33. Coil torsion springs 77 are also aligned with the ear openings 35 and knuckle passages 69. The hinge pin 71 is inserted through the aligned ear openings 35, knuckle passages 69 and coil torsion springs 77 to pivotally interconnect the parts of the ring binder mechanism 1. Opposite ends of the coil torsion springs 77 engage opposite ones of the first and second frame members 19, 21 to bias them to the open position. The ring binder mechanism 1 is ready for attachment to a ring binder 5, or for use independently of a ring binder.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A ring binder mechanism for retaining loose leaf pages on a base structure, the mechanism comprising:
a frame made of a first material;
at least one ring mounted on the frame and adapted to hold the loose leaf pages for movement along the ring;
a bracket for use in mounting the frame on the base structure, the frame being pivotally connected to the bracket, and the bracket being made of a second material that is of a different malleability than the first material.

2. A ring binder mechanism as set forth in claim 1 wherein the first material of the frame is less malleable than the second material of the bracket.

3. A ring binder mechanism as set forth in claim 2 wherein the frame material comprises a first sheet metal and the bracket material comprises a second sheet metal.

4. A ring binder mechanism as set forth in claim 2 further comprising a hinge pin interconnecting the frame and bracket.

5. A ring binder mechanism as set forth in claim 4 wherein the frame comprises thin, flat ears projecting outwardly from the frame and having openings receiving the hinge pin through the ears.

6. A ring binder mechanism as set forth in claim 5 wherein the ears are formed as one piece with the frame.

7. A ring binder mechanism as set forth in claim 5 wherein the bracket comprises a knuckle defining a passage having opposite ends and receiving the hinge pin through the passage.

8. A ring binder mechanism as set forth in claim 7 wherein the bracket comprises plural knuckles, one of the ears of the frame being located at each end of the passage of each knuckle.

9. A ring binder mechanism as set forth in claim 8 wherein the ears are formed as one piece with the frame and the knuckles are formed as one piece with the bracket.

10. A ring binder mechanism as set forth in claim 9 wherein the ring comprises first and second ring members, and the frame comprises first and second frame elements, the first ring member being mounted on the first frame element and the second ring member being mounted on the second frame element.

11. A ring binder mechanism as set forth in claim 10 wherein the first ring member is formed with a protrusion at a distal end, and the second ring member is formed with a recess at a distal end adapted to receive the protrusion of the first ring member whereby the first and second ring members are held from transverse displacement relative to each other.

12. A ring binder mechanism as set forth in claim 10 wherein some of the ears of the frame are associated with the first frame element and some the ears are associated with the second frame element whereby the first and second frame elements are pivotable about the hinge pin between a closed position wherein the ring members of the ring form a substantially continuous, closed loop for allowing loose-leaf pages retained by the ring to be moved along the ring from one ring member to the other, and an open position wherein the ring members of the ring form a discontinuous, open loop for adding or removing loose-leaf pages from the ring.

13. A ring binder mechanism as set forth in claim 12 wherein the frame further comprises a locking device for locking the first and second frame elements in the closed position.

14. A ring binder mechanism for retaining loose leaf pages, the mechanism comprising:
a frame including a first frame element and a second frame element, the first and second frame elements including spaced apart ears;
at least one ring comprising a first ring member mounted on the first frame element and a second ring member mounted on the second ring element;
a hinge pin for interconnecting the first and second frame elements for pivoting motion relative to each other between a closed position wherein the ring members of the ring form a substantially continuous, closed loop for allowing loose-leaf pages retained by the ring to be moved along the ring from one ring member to the other, and an open position wherein the ring members of the ring form a discontinuous, open loop for adding or removing loose-leaf pages from the ring by inserting the hinge pin through the ears of the first and second frame elements.

15. A ring binder mechanism as set forth in claim 14 wherein the ears are formed as one piece with respective ones of the first and second frame elements.

16. A ring binder mechanism as set forth in claim 14 wherein the ears are thin and flat and project laterally outwardly from the first and second frame elements.

17. A ring binder mechanism as set forth in claim 14 wherein the frame further comprises locking device for releasably locking the first and second frame elements in the closed position.

18. A ring binder mechanism as set forth in claim 17 wherein the locking device comprises a lock bar slidably mounted on the first frame element for movement between a locked position in which the lock bar is positioned to engage the second frame element and hold it in the closed position of the frame elements, and an unlocked position in which the lock bar disengages the second frame element to permit the first and second frame elements to pivot to the open position.

19. A ring binder mechanism as set forth in claim 18 wherein the second frame element has at least one catch formed as one piece with the second frame element for engagement with the lock bar in the locked position.

20. A ring binder mechanism as set forth in claim 19 wherein the frame further comprises a spring biasing the first and second frame elements to the open position.

21. A ring binder mechanism as set forth in claim 14 further comprising a bracket for use in mounting the frame on a base structure, the bracket having at least one knuckle formed as one piece with the bracket and receiving the hinge pin therethrough to connect the frame to the bracket.

22. A ring binder mechanism as set forth in claim 14 wherein one of the first and second ring members is formed with a protrusion at a distal end of said one ring member, and the other of the first and second ring members is formed with a recess at a distal end of said other ring member adapted to receive the protrusion in the closed position whereby the first and second ring members are held from transverse displacement relative to each other in the closed position.

23. A ring binder mechanism for retaining loose leaf pages on a base structure, the mechanism comprising:
a frame;
at least one ring mounted on the frame and adapted to hold the loose leaf pages for movement along the ring;
a bracket for mounting the frame on the base structure, the bracket including spaced apart ears; and
a hinge pin for pivotally interconnecting the frame to the bracket by inserting the hinge pin through a portion of the frame and the ears of the bracket.

24. A ring binder mechanism as set forth in claim 23 wherein said portion of the frame comprises spaced apart ears.

25. A ring binder mechanism as set forth in claim 24 wherein said frame comprises a first frame element and a second frame element.

26. A ring binder mechanism as set forth in claim 23 wherein said frame is made of a first material and said bracket is made of a second material.

27. A ring binder mechanism as set forth in claim 26 wherein said first material has a different malleability than said second material.

28. A ring binder mechanism as set forth in claim 23 wherein said ears are formed as one piece with the bracket.

29. A method of manufacturing a ring mechanism for retaining loose leaf pages comprising:
forming a generally planar frame element blank having ears with openings, the ears projecting from the blank and, lying generally in the plane of the blank;
bending the ears so that the ears lie substantially in a plane forming an angle with the plane of the blank;
mounting ring members on the blank, the ring members being adapted to mate with other ring members to form a closed ring for retaining the loose leaf pages;
inserting a hinge pin through the bent ears whereby a frame element made from the frame element blank is pivotable on the hinge pin.

30. A method as set forth in claim 29 wherein forming the generally planar frame element blank comprises stamping the frame element blank from sheet metal.

31. A method as set forth in claim 30 wherein forming the generally planar frame element blank further includes stamping the sheet metal to form tabs, the ears being formed at opposite ends of the tabs.

32. A method as set forth in claim 31 further comprising bending the tabs out of the plane of the blank, the ears forming an angle with the tabs and the plane of the blank.

33. A method as set forth in claim 29 further comprising forming a bracket and connecting the bracket to the frame element with the hinge pin whereby the frame can pivot relative to the bracket.

34. A method as set forth in claim 33 wherein forming the bracket comprises forming the bracket from a sheet metal material and forming the frame element blank comprises forming the frame element blank from sheet metal less malleable than the sheet metal material forming the bracket.

35. A method as set forth in claim 34 wherein forming a bracket comprises rolling a portion of the bracket to form a knuckle for receiving the hinge pin.

36. A method as set forth in claim 29 wherein the frame element constitutes a first frame element, the method further comprising forming a second frame element in substantially the same way as the first element such that the second frame element has said other ring members mounted thereon and the first and second frame elements are pivotable relative to each other on the hinge pin.

37. A method as set forth in claim 36 further comprising forming the ring members at their distal ends to resist transverse displacement relative to each other when the ring members are engaged with each other.
